(19) United States
(12) Patent Application Publication
(10) Pub. No.: US 2013/0141216 A1
(43) Pub. Date: Jun. 6, 2013

(54) HANDHELD DEVICE AND METHOD FOR CONTROLLING ELECTRONIC DEVICE

(71) Applicants: MING-CHUAN KAO, Tu-Cheng (TW); HSUAN-HAO KUO, Tu-Cheng (TW); JEN-HSIUNG CHARNG, Tu-Cheng (TW)

(72) Inventors: MING-CHUAN KAO, Tu-Cheng (TW); HSUAN-HAO KUO, Tu-Cheng (TW); JEN-HSIUNG CHARNG, Tu-Cheng (TW)

(73) Assignee: HON HAI PRECISION INDUSTRY CO., LTD., Tu-Cheng (TW)

(21) Appl. No.: 13/587,939

(22) Filed: Aug. 17, 2012

(30) Foreign Application Priority Data
Dec. 1, 2011 (TW) 100144181

(51) Int. Cl. H04Q 5/22

(52) U.S. Cl. 340/10.1

(57) ABSTRACT

A method for controlling electronic devices using a handheld device, one or more electronic devices are searched in a current location. The method obtains configuration documents of different locations from a storage device of the handheld device, determines a configuration document which has the most quantity or ratio of the searched electronic devices, and obtains an indicating direction of the handheld device. The method further compares the indicating direction of the handheld device with a display direction of each of electronic devices recorded in the determined configuration document, determines a matched electronic device corresponding to the indicating direction of the handheld device, and controls the matched electronic device to perform corresponding functions according to movement data or touch operations of the handheld device.

### BACKGROUND

1. Technical Field

Embodiments of the present disclosure relate to remote control technology, and particularly to a handheld device and method for controlling an electronic device remotely using the handheld device.

2. Description of Related Art

Handheld device (e.g., smart phones) have been used as remote-control units to control electronic devices, such as televisions and digital video disk (DVD) players. However, a target device to be controlled must be selected manually by a user from a target device list in the handheld device. Then, the handheld device controls the selected target device to perform functions in response to receiving user operations on a keypad (including physical keys or software buttons) of the handheld device. Therefore, an efficient method for controlling electronic devices remotely is desired.

### BRIEF DESCRIPTION OF THE DRAWINGS

FIG. 1 is a schematic diagram of one embodiment of a handheld device connected with a plurality of electronic devices.

FIG. 2 is a schematic diagram of one embodiment of the handheld device including a remote control system.

FIG. 3 is a schematic diagram of function modules of the remote control system included in the handheld device.

FIG. 4 is a flowchart of one embodiment of a method for remotely controlling electronic devices using the handheld device.

FIG. 5 is a schematic diagram of an example of an indicating direction of the handheld device.

FIGS. 6A-6C are schematic diagrams of examples of movements of the handheld device.

FIG. 7 is a schematic diagram of an example of a display direction of one electronic device.

FIG. 8A and FIG. 8B are schematic diagrams of examples for determining a match electronic device corresponding to the handheld device.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

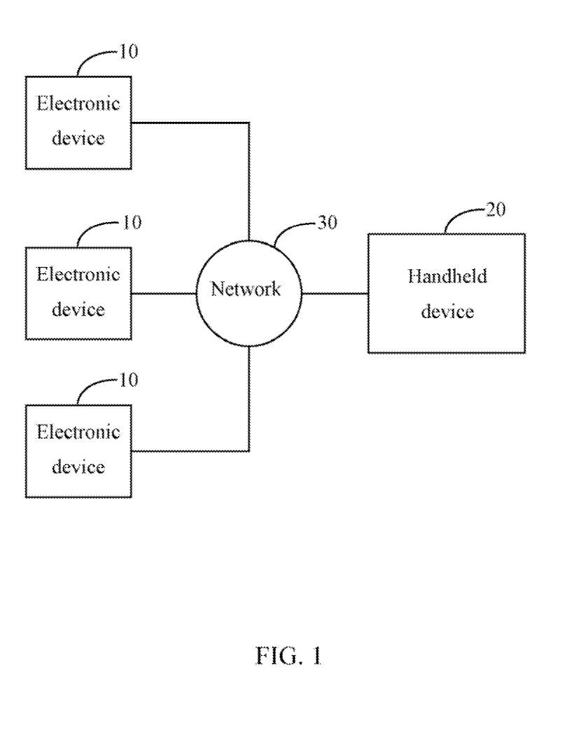

FIG. 1 is a schematic diagram of one embodiment of a handheld device 20 connected with a plurality of electronic devices 10. The handheld device 20 is connected to the electronic devices 10 through a network 30, such as a wireless network. The handheld device 20 may be a smart phone or a personal digital assistant (PDA). The electronic devices 10 comply with a digital living network alliance (DLNA) protocol, for example, the electronic devices 10 may be a digital media server (DMS), a digital media renderer (DMR), and a digital media player (DMP).

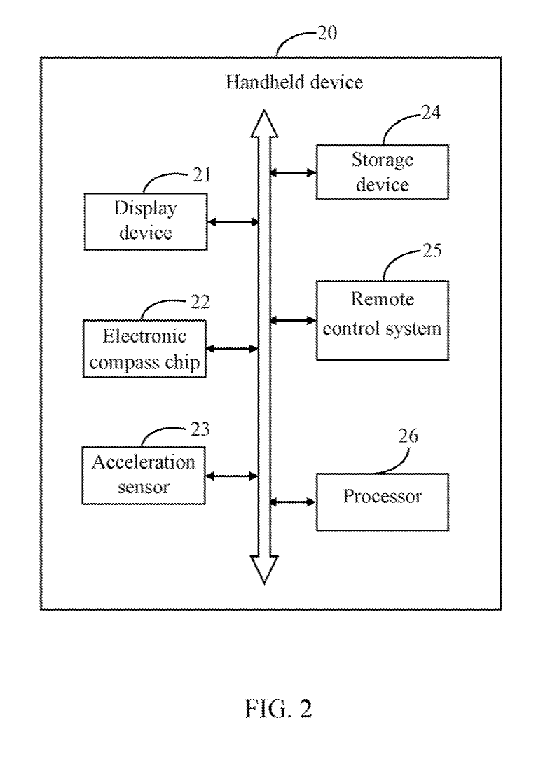

FIG. 2 is a block diagram of one embodiment of the handheld device 20 including a remote control system 25. The handheld device 20 further includes a display device 21, an electronic compass chip 22, an acceleration sensor 23, a storage device 24, and at least one processor 26. It should be understood that FIG. 2 illustrates only one example of the handheld device 20 that may include more or fewer components than illustrated, or have a different configuration of the various components in other embodiments.

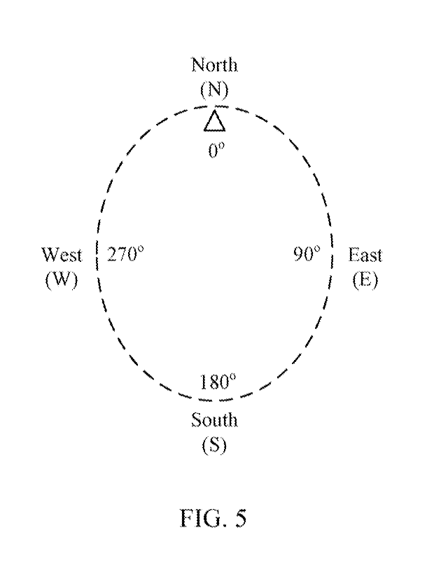

The display device 21 may be a liquid crystal display (LCD), a touch sensitive screen, or other display device. The electronic compass chip 22 is used to detect an indicating direction of the handheld device 20 (i.e., a direction in which the handheld device 20 is pointing). For example, as shown in FIG. 5, the indicating direction of the handheld device 20 may be north)(0°, east)(90°, south)(180°, and west) (270°. In one embodiment, the indicating direction of the handheld device 20 is recorded using degrees. For example, “45°” represents forty-five degrees north-east, “90°” represents east, and “270°” represents west.

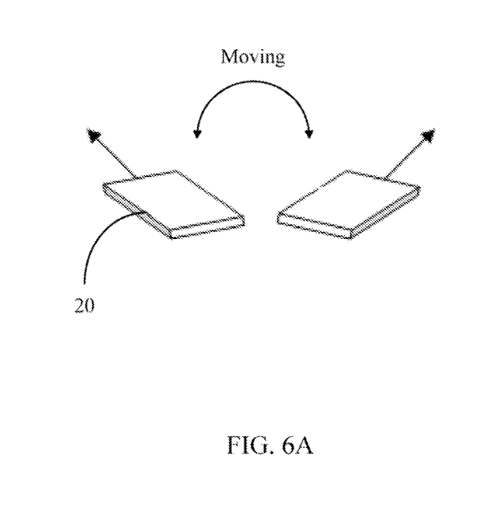

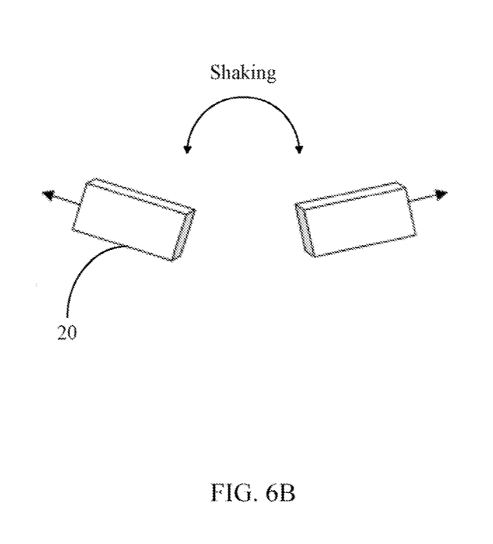

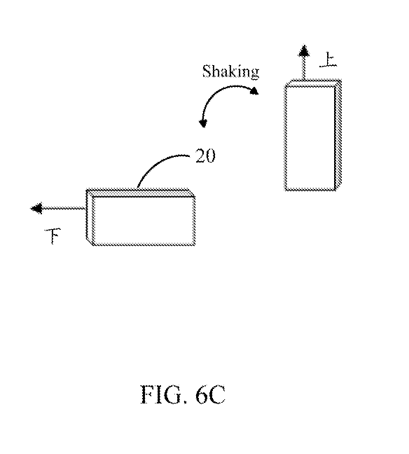

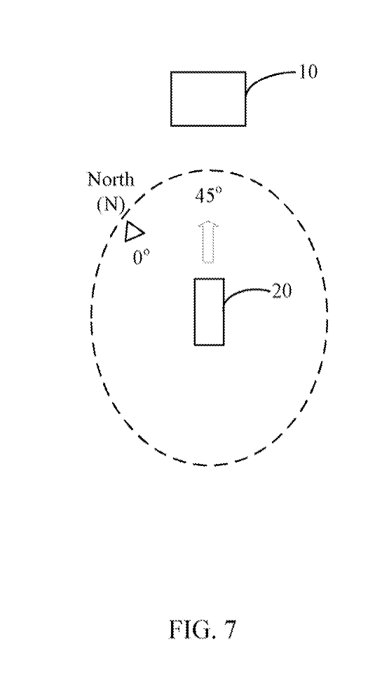

The acceleration sensor 23 is used to detect movement data of the handheld device 20 by obtaining acceleration values of the handheld device 20 in an X-axis, a Y-axis, and a Z-axis, and determining a gradient degree in the X-axis, the Y-axis, and the Z-axis according to the acceleration values, to obtain the movement data of the handheld device 20. For example, a first example of a horizontal movement of the handheld device 20 is shown in FIG. 6A, a second example of a vertical movement towards the left and the right of the handheld device 20 is shown in FIG. 6B, a third example of a vertical movement up and a vertical movement down of the handheld device 20 is shown in FIG. 6C.

The remote control system 25 is used to determine an electronic device 10 to be controlled by the handheld device 20 according to the indicating direction of the handheld device 20 detected by the electronic compass chip 22, and controls the determined electronic device 10 to perform functions according to the movement data of the handheld device 20 detected by the acceleration sensor 23. In one embodiment, the remote control system 25 may include computerized instructions in the form of one or more programs that are executed by the at least one processor 26 and stored in the storage device 24 (or memory). A detailed description of the remote control system 25 will be given in the following paragraphs.

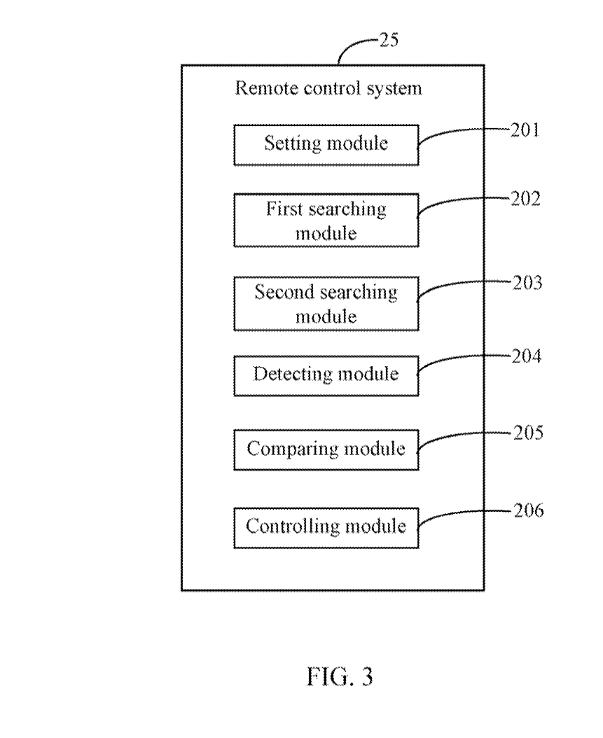

FIG. 3 is a block diagram of function modules of the remote control system 25 included in the handheld device 20. In one embodiment, the remote control system 25 may include one or more modules, for example, a setting module 201, a first searching module 202, a second searching module 203, a detecting module 204, a comparing module 205, and a controlling module 206. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

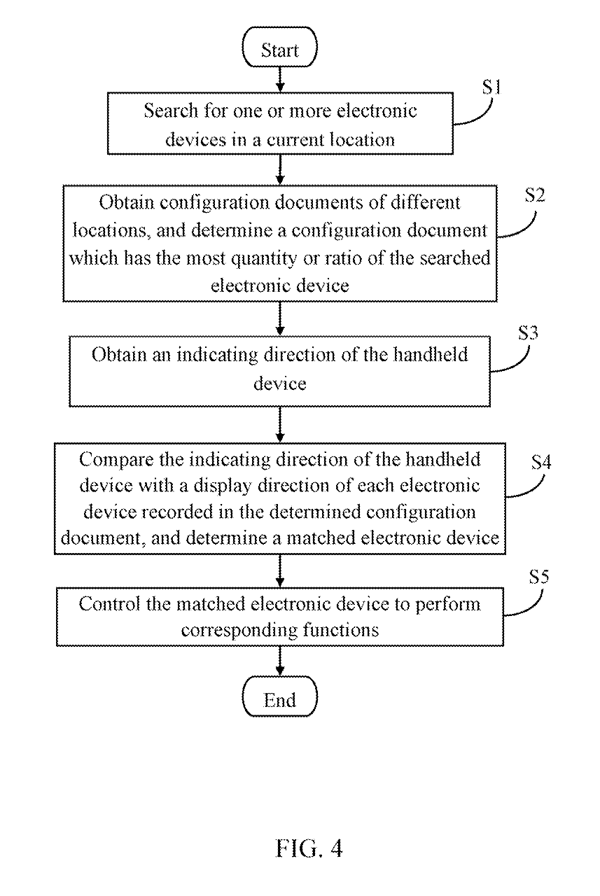

FIG. 4 is a flowchart of one embodiment of a method for remotely controlling the electronic devices 10 using the handheld device 20. Depending on the embodiment, additional steps may be added, others removed, and the ordering of the steps may be changed.

Before describing the flowchart of FIG. 4, a user of the handheld device 20 sets a display direction of each of the electronic devices 10 within a specified location (e.g., a meeting room or a living room) using the setting module 201. The setting module 201 stores an identifier and the display direction of each electronic device 10 in a configuration document of the specified location. A plurality of configuration documents for different locations may be set using the setting module 201, and stored in the storage device 24.

For example, the identifier of the electronic device 10 may be a globally unique identifier (GUID) of the electronic device 10, or may be set by the user manually. In one embodiment, the configuration documents are set when the handheld device 20 is in a horizontal state (e.g., as shown in FIG. 6A). The handheld device 20 is determined to be in the horizontal state when an included angle between the handheld device 20 and a horizontal plane is less than a preset value (e.g., thirty degrees), or the handheld device 20 is determined to be in a vertical state when the included angle between the handheld device 20 and the horizontal plane is greater than or equal to the preset value of thirty degrees.

An example of setting the display directions of the electronic devices 10 at the specified location is as follows. The user points the handheld device 20 towards the electronic device 10, the setting module 201 records a current indicating direction of the handheld device 20 as detected by the electronic compass chip 22, and determines that the display direction of the electronic device 10 is the current indicating direction of the handheld device 20. For example, if the current indicating direction of the handheld device 20 is forty-five degrees, the display direction of the electronic device 10 is determined to be forty-five degrees.

The above-mentioned process is repeated until the display directions of all the electronic devices 10 within the specified location are set. The setting module 201 stores the identifier and the display direction of each electronic device 10 in the configuration document of the specified location, and further stores all the configuration documents into the storage device 24.

In step S1, the first searching module 202 searches for one or more electronic devices 10 at a current location when the remote control system 25 is selected by the user.

In step S2, the second searching module 203 obtains configuration documents of different locations from the storage device 24, and determines a configuration document which has the most quantity or ratio of the searched electronic devices 10 (i.e., the electronic devices found in step S1). The determined configuration document is regarded as the configuration document of the current location. Thus, there is no need to search all the configuration documents and then select one configuration document for the current location manually by the user because the second searching module 203 automatically determines the configuration document which is appropriate to the current location. In other embodiments, the configuration document of the current location also may be selected manually from the storage device 24.

For example, the storage device 24 may store two configuration documents of two different locations, such as “D1” and “D2”. Suppose that the configuration document “D1” stores identifiers and display directions of three electronic devices, such as “e1”, “e2”, and “e3”, and the configuration document “D2” stores identifiers and display directions of two electronic devices, such as “e3”, and “e4”, and the current location is determined to include the electronic devices “e1”, “e2”, and “e3”. Even if the electronic device “e1” is shut down, the first searching module 202 still finds two electronic devices “e2” and “e3” at the current location. The second searching module 203 will determine that it is the configuration document “D1” which includes the most in quantity (two) or in ratio (2/3) of the searched electronic devices “e2” and “e3”.

In step S3, the detecting module 204 obtains an indicating direction of the handheld device 20 detected by the electronic compass chip 22 when the handheld device 20 is pointed to one of the electronic devices 10 at the current location.

In step S4, the comparing module 205 compares the indicating direction of the handheld device 20 with a display direction of each electronic device recorded in the determined configuration document (e.g., “D1”), and obtains a matched electronic device corresponding to the indicating direction of the handheld device 20. The matched electronic device is a target device to be controlled by the handheld device 20. An example of obtaining the matched electronic device is as follows.

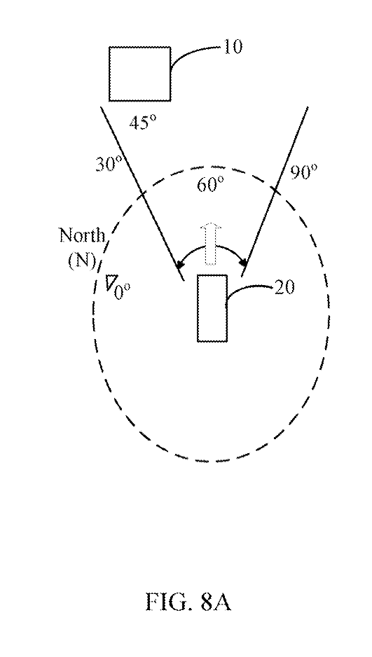

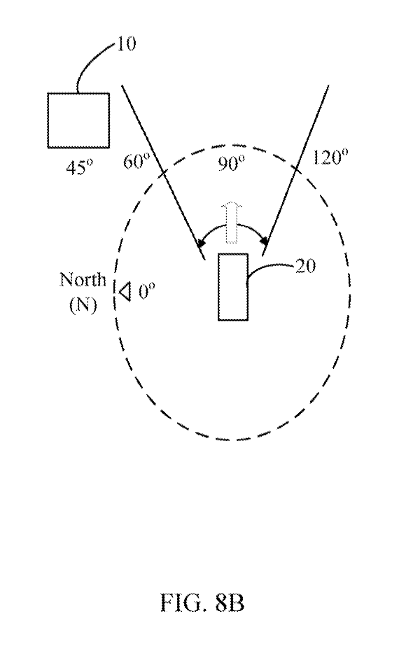

First, the comparing module 205 determines a deflection range of the indicating direction of the handheld device 20 by increasing the indicating direction of the handheld device 20 by a preset angle (e.g., 30°). For example, as shown in FIG. 8A, suppose that the indicating direction of the handheld device 20 is “60°”, where “a” represents the preset angle, thus, the deflection range of the indicating direction of the handheld device 20 is [30°, 90°].

Second, the comparing module 205 determines one particular electronic device recorded in the determined configuration document as the matched electronic device upon the condition that the display direction of the electronic device falls within the deflection range. For example, as shown in FIG. 8A, the display direction of one electronic device is forty-five degrees which falls inside the deflection range [30°, 90°], thus the comparing module 205 determines that the electronic device is the matched electronic device.

If no matched electronic device has not been found, the comparing module 205 displays a prompt message on the display device 21, to ask the user to adjust the indicating direction of the handheld device 20. For example, as shown in FIG. 8B, the indicating direction of the handheld device 20 is “90°”, and the deflection range of the indicating direction of the handheld device 20 is [60°, 120°]. The display direction (forty-five degrees) of the electronic device is out of the deflection range [60°, 120°, therefore the comparing module 205 determines that a matched electronic device has not been found.

If more than two matched electronic devices have been found, the comparing module 205 selects the electronic device whose display direction is closest to the indicating direction of the handheld device 20 as the matched electronic device.

In step S5, the controlling module 206 detects movement data of the handheld device 20 using the acceleration sensor 23, and controls the matched electronic device to perform functions corresponding to the movement data of the handheld device 20. In one embodiment, a control operation is executed when the handheld device 20 is in the vertical state, or a control operation is not executed when the handheld device 20 is in the horizontal state. A detailed description is as follows.

First, the controlling module 206 obtains a state (e.g., a horizontal state or a vertical state) of the handheld device 20 according to the included angle between the handheld device 20 and the horizontal plane. If the handheld device 20 is in the horizontal state, the procedure returns to step S4 to determine a next matched electronic device. If the handheld device 20 is in the vertical state, the controlling module 206 obtains a first mapping document from the storage device 24, the first mapping document stores a one-to-one mapping relation between the movement data of the handheld device 20 and the corresponding function executed by the matched electronic device.

Second, the controlling module 206 determines a function corresponding to the movement data of the handheld device 20, and controls the matched electronic device to perform the corresponding function. For example, if the handheld device 20 moves left in the vertical state (as shown in FIG. 6B), the controlling module 206 controls the matched electronic device to replay the previous media (for example, the last song played). If the handheld device 20 moves up in the vertical state (as shown in FIG. 6C), the controlling module 206 controls the matched electronic device to increase a volume of the matched electronic device.

In a second embodiment, the control operations are always executed whether the handheld device 20 is in the horizontal state or the vertical state.

In a third embodiment, step S5 may be executed as follows. The controlling module 206 detects a touch operation on the display device 21 of the handheld device 20, and controls the matching electronic device to perform functions corresponding to the touch operation. The touch operation may be a touch event detected on a keypad (including physical keys or software buttons) of the display device 12. A detailed description is as follows.

First, the controlling module 206 obtains a second mapping document from the storage device 24, the second mapping document stores a one-to-one mapping relation between any touch operation on the handheld device 20 and a corresponding function executed by the matched electronic device.

Second, the controlling module 206 determines a function corresponding to the touch operation on the handheld device 20, and controls the matched electronic device to perform the corresponding function. For example, if a touch operation on a left key on the display device 21 of the handheld device 20 is detected, the controlling module 206 controls the matched electronic device to play the previous song. If a touch operation on a right key on the display device 21 of the handheld device 20 is detected, the controlling module 206 controls the matched electronic device to play the next song in a playlist.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for controlling electronic devices using a handheld device comprising a processor, the method comprising:
searching one or more electronic devices in a current location;
determining a configuration document from a plurality of configuration documents that has the most quantity or ratio of the searched electronic devices, each of the configuration documents storing identifiers and display directions of the plurality of electronic devices in a specified location;
obtaining an indicating direction of the handheld device detected by an electronic compass chip of the handheld device;
comparing the indicating direction of the handheld device with a display direction of each of electronic devices recorded in the determined configuration document, and determining a matched electronic device corresponding to the indicating direction of the handheld device; and
controlling the matched electronic device to perform corresponding functions according to movement data or touch operations of the handheld device.

2. The method according to claim 1, further comprising: setting a display direction of each of the electronic devices in a specified location, and storing an identifier and the display direction of each of the electronic devices in the configuration document of the specified location.

3. The method according to claim 1, wherein the matched electronic device is determined by:
determining a deflection range of the indicating direction of the handheld device by increasing the indicating direction of the handheld device by a preset angle; and
determining an electronic device recorded in the determined configuration document as the matched electronic device upon the condition that the display direction of the electronic device falls within the deflection range.

4. The method according to claim 3, further comprising:
displaying a prompt message on a display device of the handheld device upon the condition that the matched electronic device has not been found; or
selecting the electronic device whose display direction is closest to the indicating direction of the handheld device as the matched electronic device upon the condition that more than two matched electronic devices have been found.

5. The method according to claim 1, wherein the step of controlling the matched electronic device to perform corresponding functions according to movement data of the handheld device comprises:
obtaining a first mapping document from the storage device, the first mapping document storing a one-to-one mapping relation between movement data of the handheld device and a corresponding function executed by the matched electronic device; and
determining a function corresponding to the movement data of the handheld device, and controlling the matched electronic device to perform the function.

6. The method according to claim 5, further comprising:
determining whether the handheld device is in a horizontal state or a vertical state; and
controlling the matched electronic device to perform the corresponding function upon the condition that the handheld device is in the vertical state, or determining a next matched electronic device upon the condition that the handheld device is in the horizontal state.

7. The method according to claim 1, wherein the step of controlling the matched electronic device to perform corresponding functions according to touch operations of the handheld device comprises:
obtaining a second mapping document from the storage device, the second mapping document storing a one-to-one mapping relation between any touch operation on the handheld device and a corresponding function executed by the matched electronic device;
determining a function corresponding to a touch operation on the handheld device, and controls the matched electronic device to perform the function.

8. A handheld device, comprising:
an electronic compass chip;
a storage device;
at least one processor; and
one or more modules that are stored in the storage device and are executed by the at least one processor, the one or more modules comprising:
a first searching module that searches one or more electronic devices in a current location;
a second searching module that determines a configuration document from a plurality of configuration documents that has the most quantity or ratio of the searched electronic devices, each of the configuration documents storing identifiers and display directions of the plurality of electronic devices in a specified location;
a detecting module that obtains an indicating direction of the handheld device detected by the electronic compass chip;
a comparing module that compares the indicating direction of the handheld device with a display direction of each of electronic devices recorded in the determined configuration document, and determines a matched electronic device corresponding to the indicating direction of the handheld device; and
a controlling module that controls the matched electronic device to perform corresponding functions according to movement data or touch operations of the handheld device.

9. The handheld device according to claim 8, wherein the one or more modules further comprise: a setting module that set a display direction of each of the electronic devices in a specified location, and stores an identifier and the display direction of each of the electronic devices in the configuration document of the specified location.

10. The handheld device according to claim 8, wherein the matched electronic device is determined by:
determining a deflection range of the indicating direction of the handheld device by increasing the indicating direction of the handheld device by a preset angle; and
determining an electronic device recorded in the determined configuration document as the matched electronic device upon the condition that the display direction of the electronic device falls within the deflection range.

11. The handheld device according to claim 10, wherein the comparing module further:
displays a prompt message on a display device of the handheld device upon the condition that the matched electronic device has not been found; or
selects the electronic device whose display direction is closest to the indicating direction of the handheld device as the matched electronic device upon the condition that more than two matched electronic devices have been found.

12. The handheld device according to claim 8, wherein the controlling module controls the matched electronic device to perform corresponding functions according to movement data of the handheld device by:
obtaining a first mapping document from the storage device, the first mapping document storing a one-to-one mapping relation between movement data of the handheld device and a corresponding function executed by the matched electronic device; and
determining a function corresponding to the movement data of the handheld device, and controlling the matched electronic device to perform the function.

13. The handheld device according to claim 12, wherein the controlling module further:
determines whether the handheld device is in a horizontal state or a vertical state; and
controls the matched electronic device to perform the corresponding function upon the condition that the handheld device is in the vertical state, or determines a next matched electronic device upon the condition that the handheld device is in the horizontal state.

14. The handheld device according to claim 8, wherein the controlling module controls the matched electronic device to perform corresponding functions according to touch operations of the handheld device by:
obtaining a second mapping document from the storage device, the second mapping document storing a one-to-one mapping relation between any touch operation on the handheld device and a corresponding function executed by the matched electronic device;
determining a function corresponding to a touch operation of the handheld device, and controls the matched electronic device to perform the function.

15. A non-transitory storage medium having stored thereon instructions that, when executed by a processor of a handheld device, causes the handheld device to perform a method for controlling electronic devices, the method comprising:
searching one or more electronic devices in a current location;
determining a configuration document from a plurality of configuration documents that has the most quantity or ratio of the searched electronic devices, each of the configuration documents storing identifiers and display directions of the plurality of electronic devices in a specified location;
obtaining an indicating direction of the handheld device detected by an electronic compass chip of the handheld device;
comparing the indicating direction of the handheld device with a display direction of each of electronic devices recorded in the determined configuration document, and determining a matched electronic device corresponding to the indicating direction of the handheld device; and
controlling the matched electronic device to perform corresponding functions according to movement data or touch operations of the handheld device.

16. The non-transitory storage medium according to claim 15, wherein the matched electronic device is determined by:
determining a deflection range of the indicating direction of the handheld device by increasing the indicating direction of the handheld device by a preset angle; and
determining an electronic device recorded in the determined configuration document as the matched electronic device upon the condition that the display direction of the electronic device falls within the deflection range.

17. The non-transitory storage medium according to claim 16, wherein the method further comprises:
displaying a prompt message on a display device of the handheld device upon the condition that the matched electronic device has not been found; or
selecting the electronic device whose display direction is closest to the indicating direction of the handheld device as the matched electronic device upon the condition that more than two matched electronic devices have been found.

18. The non-transitory storage medium according to claim 15, wherein the step of controlling the matched electronic device to perform corresponding functions according to movement data of the handheld device comprises:
obtaining a first mapping document from the storage device, the first mapping document storing a one-to-one mapping relation between movement data of the handheld device and a corresponding function executed by the matched electronic device; and
determining a function corresponding to the movement data of the handheld device, and controlling the matched electronic device to perform the function.

19. The non-transitory storage medium according to claim 18, wherein method further comprises:
determining whether the handheld device is in a horizontal state or a vertical state; and
controlling the matched electronic device to perform the corresponding function upon the condition that the handheld device is in the vertical state, or determining a next matched electronic device upon the condition that the handheld device is in the horizontal state.

20. The non-transitory storage medium according to claim 15, wherein the step of controlling the matched electronic device to perform corresponding functions according to touch operations of the handheld device comprises:
obtaining a second mapping document from the storage device, the second mapping document storing a one-to-one mapping relation between any touch operation on the handheld device and a corresponding function executed by the matched electronic device;
determining a function corresponding to a touch operation of the handheld device, and controls the matched electronic device to perform the function.
